(19) United States
(12) Patent Application Publication
(10) Pub. No.: US 2003/0210197 A1
(43) Pub. Date: Nov. 13, 2003

(54) Multiple mode broadband ridged horn antenna

(75) Inventors: Thomas P. Cencich, Littleton, CO (US); Jason B. Burford, Arvada, CO (US); Julie A. Huffman, Highlands Ranch, CO (US); William N. Kefauver, Littleton, CO (US)

Correspondence Address: MICHAEL BEST & FRIEDRICH, LLP, 100 E WISCONSIN AVENUE, MILWAUKEE, WI, 53202, US

(73) Assignee: Lockheed Martin Corporation, Bethesda, MD (US)

(21) Appl. No.: 10/140,975

(22) Filed: May 8, 2002

(51) Int. Cl. H01Q 13/00; H01Q 1/50

(52) U.S. Cl. 343/786; 343/850

(57) ABSTRACT

A ridged horn antenna that is designed to operate simultaneously in multiple modes with improved efficiency and higher gain. In one embodiment, the antenna has at least five ridges (e.g., eight ridges). Preferably, each ridge is independently fed by a feedline (e.g., coaxial cable). In order to match impedances better, the feedlines can be tapered from an uncoupled state to a highly coupled state. A beamforming network having a plurality of ports can be coupled to the feedlines. Preferably, the beamforming network is designed to provide multiple progressive phase relationships to the ridges through the coupled feedlines for simultaneous multiple operating modes.

### BACKGROUND OF THE INVENTION

The present invention relates to broadband antennas, and more particularly to broadband ridged horn antennas.

Spiral class antennas are commonly used as the radiator for broadband multiple mode antenna systems. Spiral antennas operate over a large bandwidth and generate large beamwidths. However, spiral antennas typically have low efficiency and low gain. A more efficient antenna capable of generating multiple modes is thus desirable.

Conventional broadband ridged horn antennas can operate over a 10:1 bandwidth, similar to spiral class antennas. Horn antennas historically have at most four ridges and are used to generate single or dual linear polarization. As shown in FIGS. 1 and 2, a conventional ridged horn antenna 20, shown as a conical quad-ridged horn, has four exponentially tapered ridges 21, 22, 23, and 24. Two ridges 21, 23 form a pair 26 of opposite ridges, and two other ridges 22, 24 form another pair 28 of opposite ridges. The ridges 21-24 are excited by feeding each pair 26, 28 with voltages that are 180° degrees out of phase. This is traditionally accomplished by feeding each pair 26, 28 with coaxial cable 30. As shown in FIG. 2, the coaxial cable 30 has an outer conductor 32 and an inner conductor 34. As is known in the art, the inner conductor 34 carries current that is 180° degrees out of phase from the current carried on the outer conductor 32. The inner conductor 34 and outer conductor 32 are electrically coupled to opposing ridges (e.g., ridge 22 and ridge 24).

Typically, ridged horn antennas are more desirable than spiral or sinuous antennas because horns are more efficient radiators. Unlike planar spiral or sinuous antennas, horn antennas do not produce a large back lobe in their radiation pattern. Thus horn antennas provide a larger gain. However, conventional ridged horn antennas are not capable of operating in multiple modes.

### SUMMARY OF THE INVENTION

The present invention provides a ridged horn antenna that is designed to have improved efficiency and higher gain. In one embodiment, the antenna has at least five ridges (e.g., eight ridges). Preferably, each ridge is independently fed by a feedline (e.g., coaxial cable). In order to better match impedances, the feedlines can be tapered from an uncoupled state to a highly coupled state. A beamforming network having a plurality of ports can be connected to the feedlines. Preferably, the beamforming network is configured to provide a progressive phase relationship to the ridges through the independent feedlines. The beamforming network can also be configured to allow excitation of the ridges in multiple modes.

The structure of the present invention allows the practice of a novel method of transmitting a signal using a ridged horn antenna having at least a first and second opposing ridges. The method comprises exciting the first ridge with a first voltage and exciting the second ridge with a second voltage in phase with the first signal. In addition, the method can include changing the phase relationship between the first and second ridges (e.g., to a progressive phase relationship). Preferably, the method further includes exciting the ridges in a first operational mode (e.g., mode 1) and exciting the ridges in a second operational mode (e.g., mode 2) different than the first operational mode. The polarization can be linear or circular, and either right-hand or left-hand circular.

As is apparent from the above, it is an advantage of the invention to provide an efficient broadband ridged-horn antenna capable of generating multiple modes. Other features and advantages of the invention will become apparent by consideration of the detailed description and accompanying drawings.

### BRIEF DESCRIPTION OF THE DRAWINGS

FIG. 1 is a front view of a conventional conical quad-ridged horn antenna.

FIG. 2 is a side section view of the antenna of FIG. 1 taken along lines 2-2 of FIG. 1.

FIG. 3 is a perspective view of a conical, eight-ridged horn antenna embodying the present invention.

FIG. 4 is a perspective view of a plurality of feedlines included in a feed structure that can be used to feed an antenna embodying the invention.

FIG. 5 is a cross-sectional view of the plurality of feedlines shown in FIG. 4, taken along line 5-5.

FIG. 6 a side section view of an individually-fed, conical, eight-ridged horn antenna system embodying the invention.

FIG. 7 illustrates the radiation patterns generated by the multi-ridged horn antenna shown in FIG. 6.

FIG. 8 illustrates the phase angle of each ridge of the antenna shown in FIG. 6 to produce left-hand circular polarization in mode 1.

FIG. 9 illustrates the phase angle of each ridge of the antenna shown in FIG. 6 to produce right-hand circular polarization in mode 1.

FIG. 10 illustrates the phase angle of each ridge of the antenna shown in FIG. 6 to produce left-hand circular polarization in mode 2.

FIG. 11 illustrates the phase angle of each ridge of the antenna shown in FIG. 6 to produce right-hand circular polarization in mode 2.

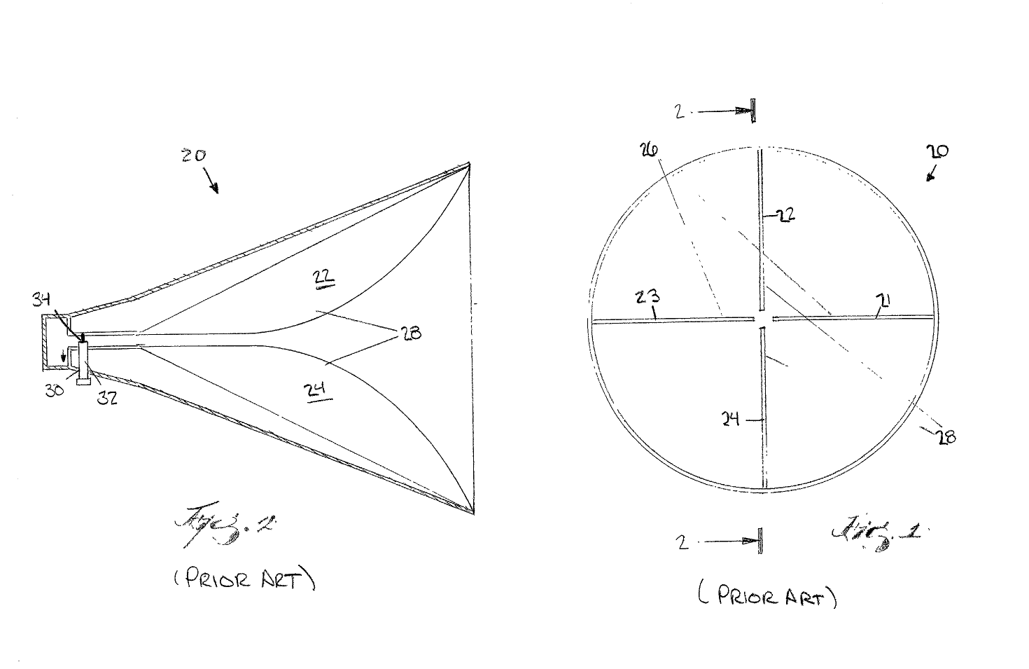

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

### DETAILED DESCRIPTION

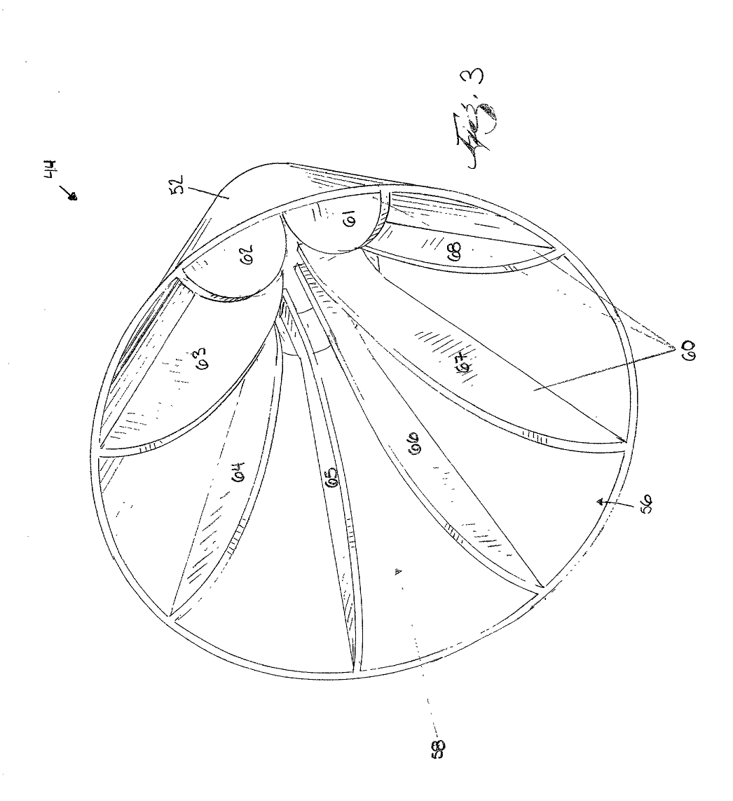

A broadband antenna system 40 embodying the invention is illustrated in FIGS. 3-6. The antenna system includes a ridged horn antenna 44 having an outer wall 52 that defines an aperture 56 through which signals are transmitted and/or received. In the embodiment shown, the horn antenna 44 has a conical outer wall 52 and a circular aperture 56. In other embodiments, the antenna 44 can vary in shape and size (e.g., pyramidal, H-plane, E-plane, etc.) and have multiple outer walls, as is known in the art. The aperture 56 can also vary in shape and size in other embodiments. The aperture 56 and outer wall 52 define a volume or horn cavity 58. The shape and size of the horn cavity 58 are factors that can affect the radiation pattern of the antenna 44, as is known in the art.

The antenna 44 further includes a plurality of ridges 60 connected to the outer wall 52 within the horn cavity 58. In the embodiment shown, the horn antenna 44 includes eight ridges 61-68 that are exponentially tapered. In other embodiments, the antenna 44 can include more or fewer ridges, and the ridges may or may not be exponentially tapered.

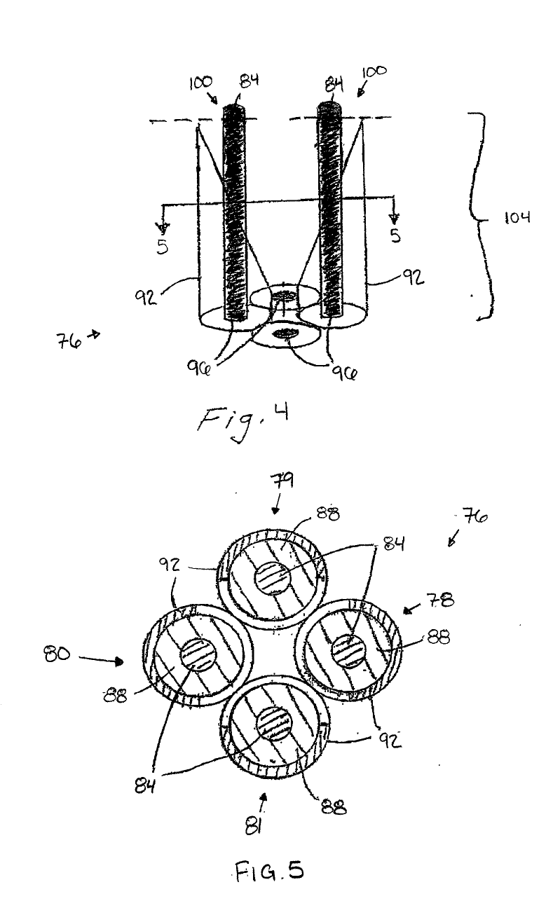

Referring to FIG. 6, the antenna system 40 further comprises a feed structure 72 including a plurality of feedlines 76. The feed structure 72 includes the same number of feedlines as the number of ridges included in the horn antenna 44, resulting in each ridge being individually fed. For the exemplary embodiment in FIG. 3, the plurality of feedlines 76 would include eight feedlines. However, for the ease of explanation, the plurality of feedlines 76 shown in FIGS. 4 and 5 include only four feedlines 78-81.

Details of the feed structure 72 are illustrated in FIGS. 4 and 5. The feedlines 76 are preferably configured from coaxial transmission line. In other embodiments, the feedlines 76 could instead be configured from microstrip transmission line or a similar transmission line.

Each feedline 78-81 includes an inner conductor 84, a dielectric layer 88 and an outer conductor 92. The dielectric layer 88 surrounds the inner conductor 84, and the outer conductor 92 surrounds the dielectric layer 88. Each feedline 78-81 further includes an uncoupled end or input end 96, a highly coupled end or Qutput end 100, and a transition section 104 found between the input end 96 and the output end 100. The feedlines 78-81 are in a substantially uncoupled state at each of the input ends 96. At the output ends 100, the feedlines 78-81 are in a highly coupled state. The transition between the uncoupled state or input end 96 to the highly coupled state or output end 100 takes place during the transition section 104. The outer conductor 92 of each feedline 78-81 is tapered in a manner that such that the transition from one state to the other is smooth. The outer conductor 92 can be tapered linearly, exponentially, stepwise or another manner that allows the states to transition smoothly. The illustrated tapering starts on the inside (i.e., the side facing the other feedlines) and moves toward the outside. Instead, the tapering could be outside to inside, side to side, or any other suitable arrangement. The dielectric layer 88 can also be tapered in the same fashion as the outer conductor 92, in a different fashion than the outer conductor 92, or not tapered at all.

Tapering each feedline 78-81, as shown in FIGS. 4 and 5, allows the feedlines 78-81 to be highly coupled. Conventional multiple mode antennas, such as multi-arm spiral antennas (not shown), have multiple antenna elements that are highly coupled. This allows the antenna to have multiple operating modes and results in a changing antenna input impedance for each mode. Highly coupled antenna elements (e.g., ridges of a horn antenna) fed by the highly coupled feedlines 78-81 allows the feed structure 72 to match the antenna impedance to the feedline impedance, and in turn match the feedline impedance to the impedance of a transmitting or receiving network (not shown). This reduces power losses from mismatch impedances and thus increases the antenna efficiency.

As shown in FIG. 6, the feed structure 72 electrically connects the ridged horn antenna 44 to a beamforming network 110 having a plurality of ports. The beamforming network 110 can consist of an N×N Butler matrix, as is known in the art, and can have any number of antenna ports (N), and any number of output ports (N). In the illustrated embodiment, the beamforming network 110 has at least eight antenna ports to accommodate each of the eight feedlines 76. In other embodiments, the beamforming network 110 has at least the same number of antenna ports as ridges 60 in the antenna 44, but may have additional or extra ports. Each ridge 61-68 of the horn antenna 44 is individually connected to the beamforming network 110 by one of the plurality 76 of feedlines at the coupled end 100 of the feedline. One feedline 114 from the plurality of feedlines 76 electrically connects one ridge 63 to one antenna port 116 of the beamforming network 110, and another feedline 118 from the plurality of feedlines 76 electrically connects another ridge 67 to another antenna port 120 of the beamforming network 110. More specifically, the inner conductor 84 on the output end 100 of the one feedline 114 is electrically coupled to the one ridge 63 and the inner conductor 84 on the output end 100 of the other feedline 118 is electrically coupled to the other ridge 67.

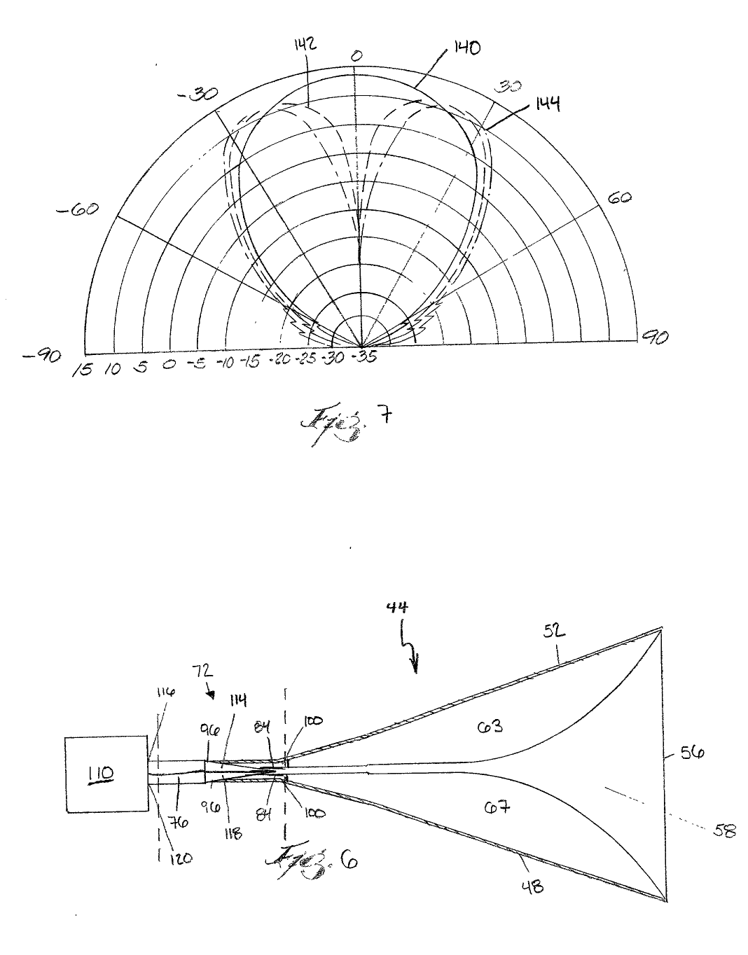

By individually coupling each ridge 61-68 with one feedline from the plurality of feedlines 76 to the beamforming network 110, the antenna system 40 can excite the ridges 61-68 with a progressive phase. Multiple operational modes similar to the modes produced by spiral antennas can be generated by feeding the ridges 61-68 of the horn antenna 44 with a progressive phase using the relationship:

$${V}_{k , m} = {V}_{0 m} {ⅇ}^{\frac{- j 2 π m ( k - 1 )}{N}} \qquad ( equation 1 )$$

wherein Vₖ is the voltage excitation of the kth arm (k equals 1, . . . N), j equals \sqrt{−1}, and V₀ₘ is a constant. The integer, m, denotes the eigenvalue or characteristic mode (m=1, 2, . . . N−1) and N is the number of ridges of the horn antenna 44. Exciting the ridges using the progressive phase equation (equation 1) will allow the horn antenna 44 to generate the multiple modes shown in FIG. 7. The radiation pattern in the solid line 140 depicts mode 1. The radiation pattern in dashed lines 142 depicts mode 2, and the other radiation pattern in dashed lines 144 depicts mode 3. Due to a larger horn aperture, the beamwidths of the patterns 140, 142, 144 are narrower than the beamwidths of a multi-mode spiral antenna pattern, almost by a factor of two. This results in a larger directivity and gain than the multi-mode planar spiral antennas.

To generate a mode 1 radiation pattern with left-hand circular polarization (“LHCP”), the ridges of a horn antenna are excited such that there is a 3600 total phase progression (or one wavelength) counterclockwise around the ridges. A mode 2 LHCP radiation pattern is produced when there is a 720° total phase progression (or two wavelengths) counterclockwise around the ridges. To generate the right-hand circular polarization (“RHCP”) modes, the ridges have the opposite phase progression (negative of the LHCP modes) for the same mode number.

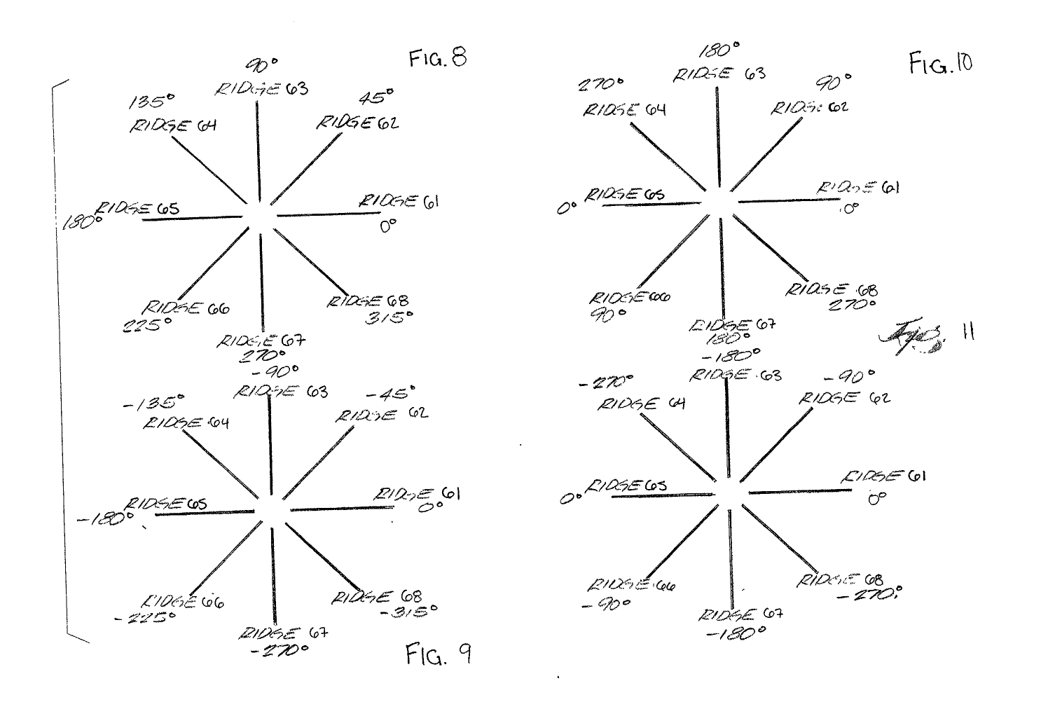

Using a ridged horn antenna having an even number of ridges, the phase relationship between opposite ridges would be out of phase or, in other words, a 180° difference when producing a LHCP mode 1 radiation pattern. FIG. 8 shows the phase relationship between ridges in an eight-ridge horn antenna producing a LHCP mode 1 radiation pattern. Ridge 61 has a phase angle of 0°, while the opposite ridge 65 has a phase angle of 180°. Ridge 62 has a phase angle of 45°, while the opposite ridge 66 has a phase angle of 225°. Ridge 63 has a phase angle of 90°, while the opposite ridge 67 has a phase angle of 270°. Also, ridge 64 has a phase angle of 135°, while the opposite ridge 68 has a phase angle of 315°. As shown in FIG. 9, to produce a RHCP mode 1 radiation pattern using an eight-ridge horn antenna, the ridges 61-68 are excited in a similar manner as the mode 1 LHCP pattern, but with a negative phase angle.

To produce a mode 2 radiation pattern for a ridged horn antenna having an even number of ridges, the phase relationship between opposite ridges would be in phase or, in other words, a 0° difference. FIG. 10 shows the phase relationship between ridges in an eight-ridge horn antenna producing a LHCP mode 2 radiation pattern. Ridge 61 and ridge 65 have a phase angle of 0°. Ridge 62 and ridge 66 have a phase angle of 90°. Ridge 63 and ridge 67 have a phase angle of 180°, while ridge 64 and ridge 68 have a phase angle of 270°. To produce a mode 2 RHCP radiation pattern, the ridges 61-68 are excited in a similar manner as the mode 2 LHCP pattern, but with a negative phase angle. The phase angles needed to generate a mode 2 RHCP radiation pattern is shown in FIG. 11.

A multiple-ridge horn antenna, such as horn antenna 44, can also simultaneously operate in multiple modes when using a Butler matrix or similar device as the beamforming network. The Butler matrix can be used to form simultaneous beams to use for scanning. Also, the output ports of a Butler matrix can be weighed and/or combined to create a combination of multiple modes.

Various features and advantages of the invention are set forth in the following claims.

What is claimed is:

1. An antenna system comprising a ridged horn antenna having at least five ridges.

2. The system as set forth in claim 1, wherein the antenna has eight ridges.

3. The system as set forth in claim 1, further comprising an independent feedline for each of the ridges.

4. The system as set forth in claim 3, wherein the feedlines are tapered.

5. The system as set forth in claim 4, wherein the tapered feedlines include an uncoupled part, a coupled part and a transition section between the uncoupled part and coupled part.

6. The system as set forth in claim 4, wherein the feedlines comprise coaxial cable.

7. The system as set forth in claim 1, wherein the antenna includes an outer wall that is conical.

8. The system as set forth in claim 1, wherein the ridges are exponentially tapered.

9. The system as set forth in claim 1, wherein the antenna has eight ridges and the system further comprises:
a tapered feedline for each ridge; and
a beamforming network having a plurality of ports coupled to the feedlines, wherein the beamforming network is designed to provide a progressive phase relationship to the ridges through the independent feedlines.

10. The system as set forth in claim 9, wherein the beamforming network is designed to provide the ridges of the horn antenna with multiple operational modes.

11. A ridged horn antenna having at least two opposing ridges and wherein each of the opposing ridges is individually fed by a feedline.

12. The antenna as set forth in claim 11, wherein the feedlines include an uncoupled part, a highly coupled part, and a transition section, and wherein the transition section is tapered.

13. The antenna as set forth in claim 12, further comprising a beamforming network having an output port, wherein the highly coupled part of one feedline is electrically interconnected to one ridge of the horn antenna and the uncoupled part of the feedline is electrically interconnected to the output port of the beamforming network.

14. The antenna as set forth in claim 11, wherein the feedlines comprise tapered coaxial cable.

15. The antenna as set forth in claim 11, wherein the antenna has eight ridges.

16. A method of transmitting a signal using a ridged horn antenna having at least a first and second opposing ridges, the method comprising:
exciting the first ridge with a first voltage; and
exciting the second ridge with a second voltage in phase with the first signal.

17. The method as set forth in claim 16, further comprising changing the phase relationship between the first and second ridges.

18. The method as set forth in claim 16, wherein the antenna includes at least four ridges, and wherein the method further comprises establishing a progressive phase relationship between adjacent ridges.

19. A method of receiving a signal using a ridged horn antenna having at least five ridges, the method comprising:
exciting the ridges in a first operational mode; and
exciting the ridges in a second operational mode different than the first operational mode.

20. The method as set forth in claim 19, wherein the steps of exciting the ridges include exciting the ridges in a progressive phase relationship.

21. The method as set forth in claim 19, wherein the ridges in the first operational mode are either right-hand or left-hand circularly polarized.

22. The method as set forth in claim 19, wherein the ridges in the second operational mode are either right-hand or left-hand circularly polarized.
